(19) United States
(12) Patent Application Publication
(10) Pub. No.: US 2008/0028090 A1
(43) Pub. Date: Jan. 31, 2008

(54) System for managing messages transmitted in an on-chip interconnect network

(76) Inventors: Sophana Kok, Voisins Le Bretonneux (FR); Philippe Boucard, Le Chesnay (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 11/518,384

(22) Filed: Sep. 8, 2006

(30) Foreign Application Priority Data
Jul. 26, 2006 (FR) FR 0606833

(51) Int. Cl. G06F 15/16

(52) U.S. Cl. 709/230

(57) ABSTRACT

Method for managing messages transmitted in an on-chip interconnect network (3), in which a sender agent (6) sends a message requesting available processing capacity (Req_writing_1(N data)) destined for a receiver agent (8), the said message requesting capacity (Req_writing_1(N data)) comprising the destination address of the receiver agent (8) and being of size less than or equal to a predetermined size, sends an instruction message (Dispatch_of_N_data) when the receiver agent (8) is ready to process the said instructions, and releases all or part of the memory space occupied by the said instruction message (Dispatch_of_N_data) after the said sending of the said stored instruction message (Dispatch_of_N_data).

The present invention pertains to a system and a method for managing messages transmitted in an on-chip, for example on silicon chip, interconnect network of functional blocks.

On-chip systems comprise a growing number of functional blocks or IP blocks (“Intellectual Property Blocks”) communicating via an interconnect network (“Network-on-Chip”). An interconnect network allows various functional blocks, that may be regulated by different clock frequencies or use different communication protocols, to communicate by means of a single message transport protocol.

In an on-chip system, the messages exchanged essentially comprise transactions between an initiator block and a destination block. Thus, the initiator block performs operations, such as data reads or writes from or to the destination block. Also, numerous data write or read requests, and associated responses flow between the various functional blocks, these messages comprising information to be exchanged, or useful data (“payload”), as well as information necessary for the carriage and for the processing of the messages, generally situated in the headers of the messages.

The cost of the functional blocks of an on-chip system being relatively high, it is important to utilize their operating capacity to the maximum, and to minimize the risks of absence of data at the input of these functional blocks. However, the data exchanges on the interconnect network not generally being predictible, congestions or blockages of the data traffic occur occasionally at the terminals of these functional blocks. If such a blockage propagates inside the interconnect network, the complete system can be completely disabled or paralysed. But, the higher the number of functional blocks, the more the complexity of the interconnect network increases, and it becomes difficult and expensive to predict the data traffic.

So, an aim of the invention is to avoid such a blockage of the network resulting from congestion of the data traffic at the terminals of a functional block, at reduced cost.

According to an aspect of the invention, there is proposed a system for managing messages transmitted in an on-chip interconnect network, comprising at least one sender agent and one receiver agent. The sender agent is designed to:
store an instruction message of size greater than a predetermined size;
send a message requesting available processing capacity for the sender agent, the said message requesting capacity comprising a destination address and being of size less than or equal to the said predetermined size, to the receiver agent corresponding to the said destination address;
send to the receiver agent the said stored instruction message, on receipt of a message authorizing instructions of the receiver agent when the receiver agent is ready to process the said instructions; and
release all or part of the memory space occupied by the said instruction message after the said sending of the said stored instruction message.

During, for example, a data write, the dispatching of messages of large size which would unnecessarily congest the interconnect network is avoided, when there are no resources available for processing them on their arrival. Thus, at reduced cost, one limits the risks of blockage of the on-chip system, by limiting the possibility of traffic congestion at the input of functional blocks. The functional blocks are used in an effective manner. The traffic in the interconnect network is thus made to flow more readily, and the speeds of the interconnect network and of the functional blocks are decoupled whatever the operating state of the functional blocks, and thus, in the event of traffic problem in the interconnect network, the speed of the interconnect network is not limited by the speeds of the destination functional blocks. There is total decoupling between the speed of the interconnect network and those of the destination functional blocks.

According to an embodiment, the sender agent is, furthermore, designed to send again the said message requesting capacity, on receipt of a request authorization message of the receiver agent when the receiver agent is ready to process the said capacity request.

The sender agent returns the message requesting capacity only when this message can be processed by the receiver agent. Furthermore, the receiver agent returns only a single request authorization message, and not a multitude. The congestion of the network is then limited, as well as the risks of blockages of the interconnect network.

According to another aspect of the invention, there is also proposed a system for managing messages transmitted in an on-chip interconnect network comprising at least one sender agent and one receiver agent. The receiver agent is designed to:
allocate means of processing of a message requesting available processing capacity originating from the sender agent if the receiver agent is ready to process the said capacity request. The said message requesting capacity is of size less than or equal to a predetermined size; and
send a message authorizing instructions, of size less than or equal to the said predetermined size, to the sender agent, authorizing the sender agent to send an instruction message of size greater than the said predetermined size, when the receiver agent is ready to process the said instructions, after having allocated processing means for processing the said message requesting capacity.

### Thus, the instruction message, comprising useful data of large size, for example for a data write, is sent in the interconnect network only when the receiver agent is ready to process the instructions.

In an embodiment, the receiver agent is, furthermore, designed, when the receiver agent is incapable of immediately processing the said capacity request, to store an information item representative of the receipt of the said message requesting capacity so as to wait to be ready to process the said capacity request, allocate means of processing of the said message requesting capacity and send a request authorization message to the sender agent, authorizing the resending of the message requesting capacity from the sender agent to the receiver agent. The said request authorization message is of size less than or equal to the said predetermined size.

Thus, the receiver only stores an information item, occupying little memory room, representative of the receipt of an instruction message, that it is incapable of processing immediately, originating from a sender agent. Stated otherwise, one only stores an information item of size less than that of the message, which is itself not stored. Thus the congestion of the interconnect network is limited, as well as the risks of congestion or blockage of the data traffic at the terminals of these functional blocks.

There is also proposed, according to another aspect of the invention, a system for managing messages transmitted in an on-chip interconnect network comprising at least one sender agent and one receiver agent. The sender agent is designed to:
store an instruction message;
send the said instruction message, comprising a destination address and being of size less than or equal to a predetermined size, to the receiver agent corresponding to the said destination address; and
release the whole memory space occupied by the said instruction message on receipt of an end-of-processing notification message of the receiver agent or on new sending of the said instruction message following receipt of a message authorizing instructions of the receiver agent.

The management of the memory space of the sender agent is thus optimized.

In an embodiment, the sender agent is, furthermore, designed to send to the receiver agent the said stored instruction message, on receipt of a message authorizing instructions of the receiver agent when the receiver agent is ready to process the said instructions.

According to another aspect of the invention, there is also proposed a system for managing messages transmitted in an on-chip interconnect network comprising at least one sender agent and one receiver agent. The receiver agent is designed to allocate means of processing of the said instruction message if the receiver agent is ready to process the said instruction message. The said instruction message is of size less than or equal to a predetermined size.

For a data read, the message is resent in the network only when the receiver agent is ready to process the message, one thus avoids dispatching a message unnecessarily in the network. Consequently, the receiver agent returns only a single request authorization message, and not a multitude. The congestion of the network is then limited, as well as the risks of blockages of the interconnect network.

According to an embodiment, the sender agent is designed to release the memory space occupied by a stored instruction message, after receipt of the message authorizing instructions and sending of the said stored instruction message.

The management of the memory space of the sender agent is thus optimized.

In an embodiment, the receiver agent is, furthermore, designed, when the receiver agent is incapable of immediately processing the said instruction message, to store an information item representative of the receipt of the said instruction message so as to wait to be ready to process the said instruction message, allocate means of processing of the said instruction message and send a message authorizing instructions to the sender agent, authorizing the resending of the instruction message from the sender agent to the receiver agent.

The receiver only stores an information item occupying little memory room and representative of the receipt of an instruction message originating from a sender agent, unable to be processed immediately by the receiver agent. The instruction message, for example data read, is reset in the interconnect network only when the receiver agent is ready to process it, one thus avoids unnecessarily congesting the interconnect network, and one limits the risks of blockage of the interconnect network.

According to an embodiment, the sender agent is designed to split a message of size greater than the said predetermined size into several messages of size greater than the said predetermined size. Furthermore, the said authorization message comprises a parameter representative of the maximum size of instructions that may be processed by the receiver agent. The sender agent is designed to release a part, of size equal to the said maximum size, of the memory space occupied by a stored instruction message, after receipt of the message authorizing instructions and sending of an instruction message comprising a part, of size equal to the said maximum size, of the instructions of the said stored instruction message.

The management of the memory of the sender agent is thus optimized since as soon as a part of the instructions that may be processed by the receiver agent is dispatched, said part is erased from the memory. The management of the memory of the sender agent is optimized, since right from the dispatching of a part of the instructions of a stored instruction message, this part is erased. Moreover, such a splitting makes it possible to insert other messages in the interconnect network between the split messages.

According to an embodiment, the said receiver agent is designed to reserve its processing capacities for the instruction messages originating exclusively from one of the said initiator agents.

It is then possible, for a given period, to dedicate the resources of a destination block to which a receiver agent is dedicated, to the exclusive usage of an initiator block corresponding to a sender agent, without for this purpose blocking a path in the interconnect network.

For example, the predetermined size corresponds to the size of the header of a message.

According to an embodiment, the said interconnect network comprising a request network and a distinct response network, the said management system is dedicated to the request network.

The data traffic being initiated by the initiator blocks, the latter can manage the quantity of expected responses. The invention allows the destination blocks to effectively manage the quantity of requests sent by the initiator blocks, or to limit the traffic initiated by the initiator blocks. Also the destination blocks can better anticipate the forthcoming data traffic.

According to an embodiment, the said interconnect network comprising a request network and a distinct response network, the said system for managing messages is dedicated to the response network.

A destination block can thus dispatch response messages of large size, by splitting the response messages thereof into messages of sizes such that the initiator blocks are ready to process them. One thus limits the risks of congestion and of blockage of the interconnect network.

According to an embodiment, the said sender agent is designed to manage the dispatching of instruction messages stored according to the minimum latency separating the dispatching of a message requesting capacity or of an instruction message and the receipt of the corresponding authorization message, so as to avoid the presence of data gaps during the dispatching of instruction messages.

The presence of data gaps is then limited while keeping a reduced latency. The expression data gaps is understood to mean data bits not representing any information item inside a message.

According to an embodiment, the said receiver agent is designed to store, for each possible sender agent, in the form of a queue, a predetermined number of information items representative of the receipt of messages requesting capacity or of instruction messages, of size less than or equal to the said predetermined size, originating from the sender agent corresponding to the said queue.

Thus, a receiver performs the tracking of a finite number of messages per sender, and can better anticipate the forthcoming data traffic and better manage its allocations of processing resources.

According to an embodiment, the said receiver agent is designed to process as a priority the priority requesting capacity messages or the priority instruction messages, of size less than or equal to the said predetermined size.

Thus, in the event of unavailability of the destination block, the receiver agent memorises the fact that it has rejected a priority message in the information representative of the receipt of a message requesting capacity or of instructions that it cannot process immediately. When the destination block can allocate processing resources, it allocates them as a priority to the priority message, and a message authorizing instructions is then dispatched as a priority to the sender agent which has sent the priority message. Consequently, it is not necessary to wait for the unblocking of the other non-priority messages that arrived before the priority message.

According to another aspect of the invention, there is also proposed a method for managing messages transmitted in an on-chip interconnect network, in which a sender agent sends a message requesting available processing capacity destined for a receiver agent. The said message requesting capacity comprises the destination address of the receiver agent and is of size less than or equal to a predetermined size. The sender agent sends an instruction message when the receiver agent is ready to process the said instructions, and releases all or part of the memory space occupied by the said instruction message after the said sending of the said stored instruction message.

According to another aspect of the invention, there is also proposed a method for managing messages transmitted in an on-chip interconnect network, in which a sender agent sends an instruction message destined for a receiver agent. The said instruction message comprises the destination address of the receiver agent and is of size less than or equal to a predetermined size. The sender agent sends again the said instruction message when the receiver agent is ready to process the said instructions, and releases all or part of the memory space occupied by the said instruction message on receipt of an end-of-processing notification message of the receiver agent or on new sending of the said instruction message following receipt of a message authorizing instructions of the receiver agent.

Other aims, caracteristics and advantages of the invention will appear on reading the following description, of a few wholly non-limiting examples, and referring to the appended drawings in which:

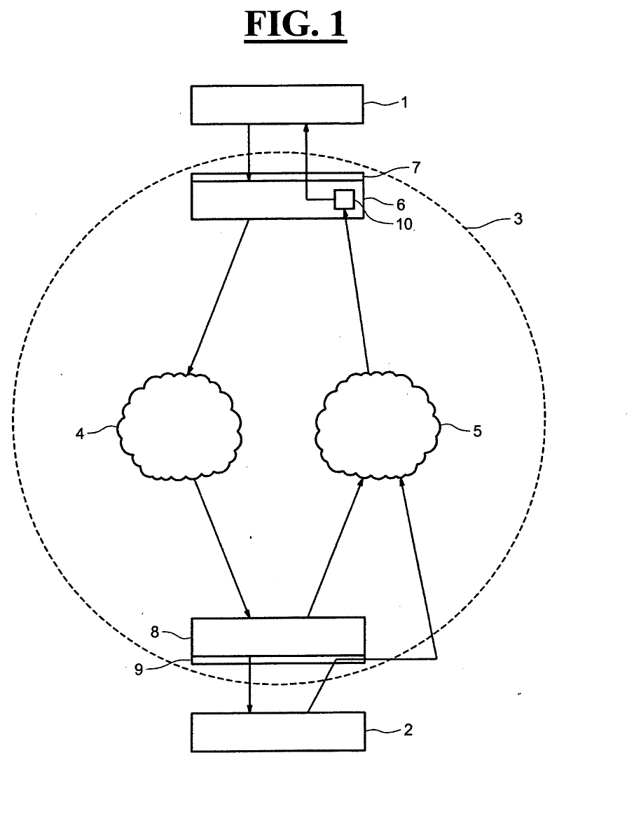

FIG. 1 diagrammatically represents a system according to an aspect of the invention;

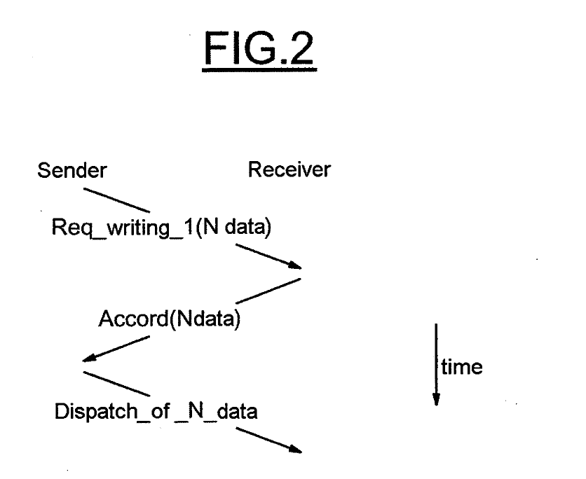

FIG. 2 illustrates the operation of a system according to FIG. 1 for a first example of transaction of writing data between a sender agent and a receiver agent;

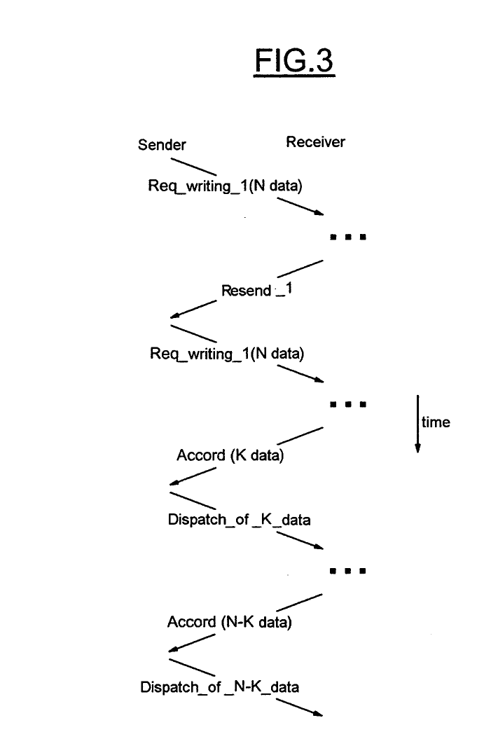

FIG. 3 illustrates the operation of a system according to FIG. 1 for a second example of transaction of writing data between a sender agent and a receiver agent;

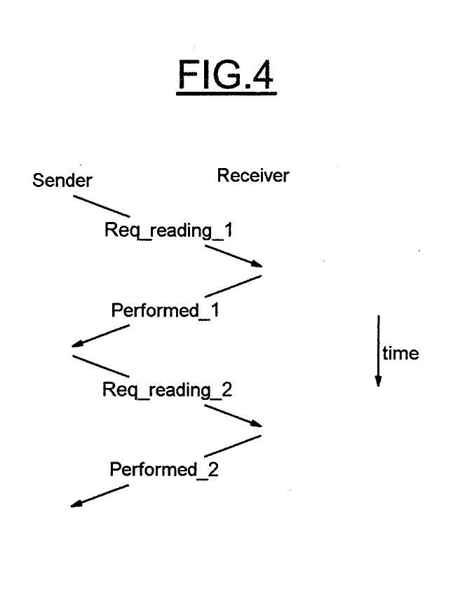

FIG. 4 illustrates the operation of a system according to FIG. 1 for a first example of transaction of reading data between a sender agent and a receiver agent; and

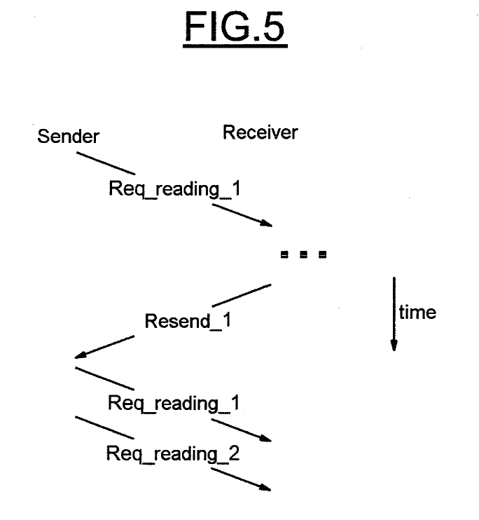

FIG. 5 illustrates the operation of a system according to FIG. 1 for a second example of transaction of reading data between a sender agent and a receiver agent.

As illustrated diagrammatically in FIG. 1, an initiator block 1 and a destination block 2 on-chip, for example silicon chip, can communicate by way of an interconnect network 3. In FIG. 1, the interconnect network 3 comprises a request network 4 and a separate response network 5. Of course, the invention also applies to systems for which the request network and the response network are not separate.

The initiator block 1 is associated with a sender agent 6 and a network interface 7 or “Socket”. The network interface 7 allows the initiator block 1 to communicate with the associated sender element 6 of the interconnect network 3, that may be regulated by a clock frequency and use a communication protocol different from those of the initiator block 1. The destination block 2 is associated with a receiver agent 8 and with a network interface 9. As a variant, the sender and receiver agents can be included in their respective network interface.

Of course, generally, the system comprises other initiator blocks and other destination blocks, that are not represented in FIG. 1.

The sender agent 6 comprises an aggregation module 10 for aggregating the statuses or acnoledgess necessary when a data transaction such as a data write, between the initiator block 1 and the destination block 2 is decomposed into several write steps of parts of the data according to an aspect of the invention described in greater detail subsequently.

The query messages sent from the sender agent 6 to the receiver agent 8 can be messages of large size, comprising useful data, such as query messages in data write mode or messages of small size, such as data read query messages. Subsequently in the description, a message of size greater than a predetermined size will be referred to as a message of large size or long message, and a message of size less than or equal to the predetermined size, for example the size of a message header, will be referred to as a message of small size or short message. Furthermore, subsequently in the description, the invention is applied to the request network, however the invention can be applied to the request network and/or to the response network.

It is also possible to have two request networks and two response networks, the additional request network and the additional response network, of lesser latency, being reserved for the transport of the short or small size messages.

In the case of a query message comprising useful data, for example a data write, such as illustrated in FIG. 2, the initiator block 1 sends a write query message to the sender agent 6, by way of the network interface 7. The sender agent 6 stores an instruction message, of large size, corresponding to the query message in data write mode. The sender agent 6 sends a message requesting available processing capacity Req_writing_1(N data), of small size, comprising a destination address. The destination address is the address of the receiver agent 8 dedicated to the destination block 2. This message requesting processing capacity Req_writing_1(N data) being of small size, causes little congestion in the interconnect network 3.

When the message requesting capacity Req_writing_1(N data) arrives at the receiver agent 8, the latter stores an information item representative of the receipt of this message requesting available processing capacity originating from the sender agent 6, when the receiver agent 8 may not process this message immediately.

The information representative of the receipt of a message requesting capacity is, for example, a set of data bits dedicated to a determined sender agent, representing the presence or otherwise of a message on standby awaiting processing, the type of processing to be performed, such as reading or writing, and the priority level. In this example, the receiver agent 8 can immediately process this message requesting capacity, and allocates means of processing of this request. Then, when the receiver agent 8 is ready to process the instructions, i.e the writing of N data, the receiver agent 8 sends a message authorizing instructions Grant(N data), of small size, to the sender agent 6, authorizing the latter to send the stored instruction message Dispatch_of_N_data. In this example, the receiver agent can immediately process the request and the instructions.

Thus, this stored instruction message Dispatch_of_N_data, of large size, is sent in the interconnect network only when the receiver agent 8 is ready to process the instructions, stated otherwise to write the N data. Long data messages thus avoid flowing in the interconnect network 3 when on their arrival their processing is not guaranteed. One thus greatly decreases the risks of congestion of the network due to the blockage of a receiver agent 8 or of the associated destination block 2.

When the receiver agent 8 is not immediately available, as illustrated in FIG. 3, after having received the message requesting available processing capacity Req_writing_1(N data), it stores an information item representative of the receipt of this unprocessed message requesting capacity, and waits to be able to allocate processing means to such a message requesting capacity. As soon as the receiver agent 8 has the capacity to allocate processing means for such a message requesting capacity, it sends a request authorization message Resend_1 to the sender agent 6, which, when it receives it, sends again the message requesting available processing capacity Req_writing_1(N data).

When the receiver agent 8 can process this message requesting capacity Req_writing_1(N data), it allocates means of processing of this message, and dispatches a request authorization message Resend_1 to the sender agent 6. When the sender agent 6 receives this request authorization message Resend_1, it sends again the message requesting capacity Req_writing_1(N data), which is processed by the receiver agent 8 as soon as it is received. Then, the receiver agent 8 waits to be able to process the corresponding instructions, or at the very least a part. As a variant, the receiver agent 8 can wait to be ready to process the whole set of instructions (N data) and not only a part (K data). When the receiver agent 8 is ready to process K data on the N corresponding instructions data stored by the sender agent 6, the receiver agent 8 sends a message authorizing instructions Grant(K data), of small size, to the sender agent 6. On receipt of this message authorizing instructions Grant(K data), the sender agent 6 dispatches an instruction message Dispatch_of_K_data comprising K stored data, for example the first K, and erases the latter from its memory.

On receipt of this instruction message Dispatch_of_K_data comprising these K data, of large size, the receiver agent 8 processes these K data, and waits to be ready to be able to process another part of these useful data of the instruction message stored in the sender agent 6. Once ready to process other data, for example the remaining N-K data, it sends a message authorizing instructions, of small size, Grant(N-K data) destined for the sender agent 6, which, on receipt, dispatches an instruction message Dispatch_of_N-K_data to the receiver agent 8. On receipt of the instruction message Dispatch_of_N-K_data, the receiver agent 8 processes the remaining N-K data.

Thus, only the messages of large size Dispatch_of_K_data and Dispatch_of_N-K_data, whose useful data can be processed as soon as the message arrives at its destination, have been sent in the network. Furthermore a single request authorization message Resend_1 and a single message authorizing instructions for a quantity of data to be processed Grant(K data) and Grant(N-K data) have been transmitted in the interconnect network 3 during this transaction. The risks of blockage and the congestion of the interconnect network 3 are thus limited.

In the case of a query message devoid of useful data, for example a data read, such as illustrated in FIG. 4, the initiator block I sends a reading query message to the sender agent 6, by way of the network interface 7. The sender agent 6 stores an instruction message, of small size, corresponding to the query message in data read mode. The sender agent 6 sends an instruction message Req_reading_1, of small size, comprising a destination address, which is a conventional data read query message. The destination address is the address of the receiver agent 8 dedicated to the destination block 2. This instruction message Req_reading_1 being of small size, causes little congestion in the interconnect network 3.

When the instruction message Req_reading_1 arrives at the receiver agent 8, the receiver agent 8 can immediately process this instruction message, and allocates means of processing of this message, and returns an end-of-processing notification message Performed_1, on receipt of which the sender agent 6 erases from its memory the stored instruction message Req_reading_1. Then, another data read transaction is performed in a similar manner, with a stored instruction message Req_reading_2, and an end-of-processing notification message Performed_2 in return.

One avoids repeatedly dispatching the stored instruction message. One thus decreases the risks of congestion of the network due to the blockage of a receiver agent 8 or of the associated destination block 2.

When the receiver agent 8 is not immediately available, as illustrated in FIG. 5, after having received the stored instruction message Req_reading_1, it stores an information item representative of the receipt of this unprocessed instruction message, and waits to be able to allocate processing means to such an instruction message. As soon as the receiver agent 8 has the capacity to allocate processing means for such an instruction message, it allocates means of processing of this message, and sends a request authorization message Resend_1 to the sender agent 6, which, when it receives it, sends again the stored instruction message Req_reading_1. Thus, when the receiver agent 8 receives again this instruction message Req_reading_1, it immediately processes it.

When a query in write mode of the initiator block I has been processed, the destination block returns a message of acknowledge by the response network 5 to the module 10 for aggregating acknowledges, which transfers an end-of-transaction acknowledge message to the initiator block 1.

When a query in write mode has been processed in several steps, by splitting the data to be processed, and the destination block 2 has dispatched several successive acknowledge messages to the aggregation module 10 corresponding respectively to the fractions of the processed data, the aggregation module 10 aggregates these various acknowledges into a single final transaction acknowledge destined for the initiator block 1.

The receiver agent 8 may be able to store only a predetermined number of information items representative of the receipt of the message requesting capacity or the instruction message sent via the sender agent (6). In an interconnect network with static routing, a path between a sender agent and a receiver agent is fixed, the messages do not overtake one another and their order is preserved. Dispatching several short messages in succession, from the sender agent 6 to the receiver agent 8 makes it possible to mask a part of the additional latency due to the back and forth transmission between the sender agent and the receiver agent.

Being easier to increase the performance of the interconnect network 3 than the performance of the functional blocks or IP blocks, generally the functional blocks are slower than the interconnect network 3, or, stated otherwise operate at a lower clock rate. So, when the sender agent 6 receives data from the initiator block 1 at a clock rate frequency below that of the network, if one does not want to have too many data gaps, the data are stored and compacted before dispatching them in the interconnect network. Of course, if the widths of the communication links are not the same on both sides of a network interface, it is necessary to compare the data throughputs (frequency multiplied by width of the link) rather than the clock rate frequencies. But storage means, generally organized in the form of queues already exist in the sender agent 6, for storing the messages on standby. It is therefore possible, without additional cost, to exploit the means of the device so as to compact the data before sending. If one desires to optimize the latency, it is possible to begin to send a write request message even before the sender agent 6 has received all the useful data. Specifically, knowing the minimum lag for dispatching the write request message to the receiver agent and receiving the first authorization to dispatch a part or the totality of the useful data, and knowing, by virtue of the content of the header of the message, the total number of data to be sent and the throughputs at the input and at the output of the sender agent, it is possible to deduce the instant at which it will be necessary to send the message requesting capacity, in order that the arrival of the last data item in the sender agent 6 coincides with the instant at which it can be sent, when there is no additional latency due to a temporary unavailability of the receiver agent 8. This is possible by virtue of the knowledge of the architecture of the interconnect network, it is possible to know the number of clock cycles to go from one point to another. The expected throughputs are also known during the dimensioning of the network.

Most of the critical destination blocks that one seeks to utilize to the maximum, as a dynamic random access memory controller or DRAM controller, are already provided with queues so as anticipate the data traffic. For example, in the DRAM controller a major problem is to minimize the number of reversals between a data read and a write, consequently to have better visibility regarding the reads and the writes on standby makes it possible to choose more effectively the best instants of reversals. The invention makes it possible to improve this visibility by providing forecasts on the forthcoming traffic upstream of the interconnect network 3. If, moreover, the short messages comprise a priority information item it is possible to allocate processing means according to this priority information item. Furthermore, if the receiver agent is occupied, the priority message will be processed before any other new message, contrary to a device in which a priority message propagates its priority through the network, which, in this situation, may be congested. The device improves the management of the queues of the destination blocks and makes it possible to improve the service quality of interconnect networks by acting on the requests on standby rather than after the choking of the network.

The invention makes it possible to avoid a blockage of data traffic at the terminals of the interconnect network, as well as an extension of such a blockage in the network. Furthermore, the risks of internal blockage of the interconnect network being lower, the discrepancies between the traffic peaks and the average traffic value are reduced, and the system is then more deterministic and therefore easier to analyses

The invention makes it possible to limit the risks of blockages of an on-chip interconnect network of IP blocks due to data traffic jams at the input of functional blocks.

1. System for managing messages transmitted in an on-chip interconnect network comprising at least one sender agent and one receiver agent, wherein the sender agent is designed to:
store an instruction message of size greater than a predetermined size;
send a message requesting available processing capacity for the sender agent, the said message requesting capacity comprising a destination address and being of size less than or equal to the said predetermined size, to the receiver agent corresponding to the said destination address;
send to the receiver agent the said stored instruction message, on receipt of a message authorizing instructions of the receiver agent when the receiver agent is ready to process the said instructions; and
release all or part of the memory space occupied by the said instruction message after the said sending of the said stored instruction message.

2. System according to claim 1, in which the sender agent is, furthermore, designed to send again the said message requesting capacity, on receipt of a request authorization message of the receiver agent when the receiver agent is ready to process the said capacity request.

3. System for managing messages transmitted in an on-chip interconnect network comprising at least one sender agent and one receiver agent, wherein the receiver agent is designed to:
allocate means of processing of a message requesting available processing capacity from the sender agent if the receiver agent is ready to process the said capacity request, the said message requesting capacity being of size less than or equal to a predetermined size; and
send a message authorizing instructions, of size less than or equal to the said predetermined size, to the sender agent, authorizing the sender agent to send an instruction message of size greater than the said predetermined size, when the receiver agent is ready to process the said instructions, after having allocated processing means for processing the said message requesting capacity.

4. System according to claim 3, in which the receiver agent is, furthermore, designed, when the receiver agent is incapable of immediately processing the said capacity request, to store an information item representative of the receipt of the said message requesting capacity so as to wait to be ready to process the said capacity request, allocate means of processing of the said message requesting capacity and send a request authorization message to the sender agent, authorizing the resending of the message requesting capacity from the sender agent to the receiver agent, the said request authorization message being of size less than or equal to the said predetermined size.

5. System for managing messages transmitted in an on-chip interconnect network comprising at least one sender agent and one receiver agent, wherein the sender agent designed to:
store an instruction message;
send the said instruction message, comprising a destination address and being of size less than or equal to a predetermined size, to the receiver agent corresponding to the said destination address; and
release the whole memory space occupied by the said instruction message on receipt of an end-of-processing notification message of the receiver agent or on new sending of the said instruction message following receipt of a message authorizing instructions of the receiver agent.

6. System according to claim 5, in which the sender agent is, furthermore, designed to send to the receiver agent the said stored instruction message, on receipt of a message authorizing instructions of the receiver agent when the receiver agent is ready to process the said instructions.

7. System for managing messages transmitted in an on-chip interconnect network comprising at least one sender agent and one receiver agent, wherein the receiver agent is designed to allocate means of processing of the said instruction message it the receiver agent is ready to process the said instruction message, the said instruction message being of size less than or equal to a predetermined size.

8. System according to claim 7, in which the receiver agent is, furthermore, designed, when the receiver agent is incapable of immediately processing the said instruction message, to store an information item representative of the receipt of the said instruction message so as to wait to be ready to process the said instruction message, allocate means of processing of the said instruction message and send a message authorizing instructions to the sender agent, authorizing the resending of the instruction message from the sender agent to the receiver agent.

9. System according to claim 1, in which the sender agent is designed to split a message of size greater than the said predetermined size into several messages of size greater than the said predetermined size, and in which the said authorization message comprises a parameter representative of the maximum size of instructions that may be processed by the receiver agent, the sender agent being designed to release a part, of size equal to the said maximum size, of the memory space occupied by a stored instruction message, after receipt of the message authorizing instructions and sending of an instruction message comprising a part, of size equal to the said maximum size, of the instructions of the said stored instruction message.

10. System according to claim 1, wherein the said receiver agent is designed to reserve its processing capacities for the instruction messages originating exclusively from one of the said sender agents.

11. System according to claim 1, wherein the said predetermined size corresponds to the size of the header of a message.

12. System according to claim 1, in which, the said interconnect network comprising a request network and a distinct response network, the said management system is dedicated to the request network.

13. System according to claim 1, in which, the said interconnect network comprising a request network and a distinct response network, the said system for managing messages is dedicated to the response network.

14. System according to claim 1, in which the said sender agent is designed to manage the dispatching of instruction messages stored according to the minimum latency separating the dispatching of a message requesting capacity or of an instruction message and the receipt of the corresponding authorization message, so as to avoid the presence of data gaps during the dispatching of instruction messages.

15. System according to claim 1, in which the said receiver agent is designed to store, for each possible sender agent, in the form of a queue, a predetermined number of information items representative of the receipt of messages requesting capacity or of instruction messages that the receiver agent is incapable of processing immediately, of size less than or equal to the said predetermined size, originating from the sender agent corresponding to the said queue.

16. System according to claim 1, in which the said receiver agent is designed to process as a priority the priority requesting capacity messages or the priority instruction messages, of size less than or equal to the said predetermined size.

17. Method for managing messages transmitted in an on-chip interconnect network, in which a sender agent sends a message requesting available processing capacity destined for a receiver agent, the said message requesting capacity comprising the destination address of the receiver agent and being of size less than or equal to a predetermined size, sends an instruction message when the receiver agent is ready to process the said instructions, and releases all or part of the memory space occupied by the said instruction message after the said sending of the said stored instruction message.

18. Method for managing messages transmitted in an on-chip interconnect network, in which a sender agent sends an instruction message destined for a receiver agent, the said instruction message comprising the destination address of the receiver agent and being of size less than or equal to a predetermined size, sends again the said instruction message when the receiver agent is ready to process the said instructions, and releases all or part of the memory space occupied by the said instruction message on receipt of an end-of-processing notification message of the receiver agent or on new sending of the said instruction message following receipt of a message authorizing instructions of the receiver agent.
